(19) United States
(12) Patent Application Publication
(10) Pub. No.: US 2009/0183559 A1
(43) Pub. Date: Jul. 23, 2009

(54) Method for Ascertaining Individual-Cylinder Rotation Parameters of a Shaft of an Internal Combustion Engine

(76) Inventors: Manfred Birk, Oberriexingen (DE); Peter Skala, Tamm (DE); Joachim Palmer, Korntal-Muenchingen (DE); Wolfram Gerwing, Hessigheim (DE); Ruediger Fehrmann, Leonberg (DE); Michael Kessler, Weissach (DE)

Correspondence Address: KENYON & KENYON LLP, ONE BROADWAY, NEW YORK, NY, 10004, US

(21) Appl. No.: 11/922,716

(22) PCT Filed: Jul. 7, 2006
(86) PCT No.: PCT/EP2006/064029

§ 371 Date: Mar. 5, 2009

(30) Foreign Application Priority Data
Jul. 28, 2005 (DE) 102005035408.4

(51) Int. Cl. G01M 15/04

(52) U.S. Cl. 73/114.27

(57) ABSTRACT

A method for operating an internal combustion engine in which a first rotation parameter is measured at a first end of a shaft of the internal combustion engine, and individual-cylinder rotation parameters are determined using the first rotation parameter. The method is characterized in that a second rotation parameter is measured at a second end of the shaft, and the individual-cylinder rotation parameters are determined using the first rotation parameter and the second rotation parameter. A control unit that controls the method is also presented.

### FIELD OF THE INVENTION

The present invention relates to a method for operating an internal combustion engine in which a first rotation parameter is measured at a first location along a shaft of the internal combustion engine, and individual-cylinder rotation parameters are determined using the first rotation parameter. The present invention further relates to a control unit that ascertains individual-cylinder rotation parameters of a shaft of an internal combustion engine using a signal of a first rotation parameter sensor that senses a first rotation parameter at a location along the shaft.

In this context, a “rotation parameter” is understood as an angular position, an angular velocity, or a torque value at a portion of the shaft. The first location is preferably a first end of the shaft.

### BACKGROUND INFORMATION

A method of this kind is described in German Patent No. DE 44 45 684 A1. With the conventional method, an angular velocity of the shaft is measured by way of an incremental transducer in the vicinity of the flywheel, in order to minimize the influence of twisting of the crankshaft. The number N of increments of the incremental transducer for one revolution is intended to be at least twice as great as the number of cylinders. Revolution-synchronous features of the incremental transducer trigger the sampling of a counter. Upon occurrence of the trigger, a present counter status is transferred to an evaluation unit, and from that the angular velocity is calculated, and from that an angular acceleration. From the angular acceleration, an inertia torque of the rotating masses, a torque of oscillating masses, and a frictional torque, and with reference back to a family of characteristic curves that was previously prepared by way of load experiments at different rotation speeds and loads and is stored in the control unit, a determination is made of an effective torque that acts on an output side of the shaft. A gas torque curve is modeled with the aid of the effective torque, and individual-cylinder torque parameters are determined from the gas torque curve.

### SUMMARY

The example method according to the present invention differs from this existing art in that a second rotation parameter is measured at a second location along the shaft, and the individual-cylinder rotation parameters are determined using the first rotation parameter and the second rotation parameter.

The example control unit according to the present invention is correspondingly notable for the fact that it ascertains the individual-cylinder rotation parameters using the signal of the first rotation parameter sensor and a signal of a second rotation parameter sensor that senses a second rotation parameter at a second location along the shaft. The second location is preferably a second end of the crankshaft.

Open- and closed-loop control methods for internal combustion engines (e.g., injection quantity compensation control for cylinder equalization) are generally directed toward systems having a torsionally stiff crankshaft, in which a single crank angle describes the position of all the crank bends. Differences in crank angle between individual cylinders, such as those that actually occur in a torsionally soft crankshaft, degrade the quality of open- and closed-loop control processes. Estimation methods for determining delivered torque are likewise disadvantageously influenced by a torsionally soft crankshaft. Output torques on both sides of the crankshafts are not measurable, and the magnitude and time profile of these unknown output torques influence the quality of the open- and closed-loop control methods.

Within this context, the invention permits a more accurate determination of individual-cylinder rotation speeds, crank angles, and torques of a torsionally soft shaft in consideration of an estimated output torque; instrumental sensing of rotation parameters on both sides permits an instrumental sensing of the shaft's torsion, and a continuous adaptation of the determination of individual-cylinder rotation parameters. This adaptation makes possible more accurate open- and closed-loop control of the internal combustion engine as compared with the existing art. The invention furthermore permits an observation of output torques, so that their effect can be taken into consideration in the open- or closed-loop control of the internal combustion engine.

With a view toward embodiments of the method, it is preferred that the first and the second rotation parameter each be ascertained as an angular velocity.

Angular velocities can be easily and accurately ascertained with commercially common rotation angle sensors. An additional advantage is the fact that a rotation angle sensor is usually already present to allow, for example, injection and/or ignition operations to be controlled synchronously with the rotation of the crankshaft.

It is also preferred that, in consideration of the first rotation parameter and the second rotation parameter, a third rotation parameter characteristic of the entire internal combustion engine be determined, and the individual-cylinder rotation parameters be determined from a model representing the internal combustion engine, input variables of the model being based on the first rotation parameter, the second rotation parameter, and the third rotation parameter.

It has been found that limitation to these three input variables already permits good modeling of individual-cylinder rotation parameters.

It is further preferred that the third rotation parameter be ascertained as a torque value of the entire internal combustion engine.

This torque value may be obtained, in a real internal combustion engine, as a sum of the individual-cylinder torque values. From the sum, conclusions can be drawn to a certain extent as to the individual summands, i.e., the individual-cylinder torque values, so that the value of the sum represents a suitable output variable for modeling the individual-cylinder torque values.

It is also preferred that the individual-cylinder rotation parameters be ascertained as individual-cylinder angular velocities and/or as individual-cylinder torque values. Irregularities in combustion events between the cylinders emerge with particular clarity in these values, so that these values are of particular interest for closed- and/or open-loop control methods.

A further embodiment is notable for the fact that the model for an n-cylinder internal combustion engine encompasses a model of its crankshaft having (n+2) segments, a first segment representing the first end of the crankshaft, further segments each individually representing an individual-cylinder segment, and the remaining (n+2)th segment representing the second end of the crankshaft, each segment having a inertia torque and a frictional torque associated with it, segments being respectively joined to one another by rotationally elastic couplings, each rotationally elastic coupling having a torsional torque associated with it, and each individual-cylinder segment exhibiting an individual-cylinder torque value derived from the third rotation parameter.

This model takes into consideration all relevant influencing variables and thus permits, for example, accurate modeling of the individual-cylinder variables.

It is also preferred that a torque value associated with the first segment be obtained, as a rotation parameter, from a deviation of the first rotation parameter from an estimated value of the first rotation parameter, and a torque value associated with the remaining (n+2)th segment be obtained from a deviation of the second rotation parameter from an estimated value for the second rotation parameter.

As a result of this embodiment, the torques effective at both ends of the crankshaft can, as it were, be observed in terms of control engineering with no need to measure the torques.

It is further preferred if individual-cylinder control variables are obtained using the individual-cylinder rotation parameters, since this considerably improves the quality of closed- and/or open-loop control processes.

With a view toward embodiments of the control unit, it is preferred that it carry out at least one of the aforesaid embodiments of the method, thus resulting in the respectively corresponding advantages.

It is understood that the features described above and those yet to be explained below are usable not only in the respective combination indicated, but also in other combinations or in isolation, without leaving the context of the present invention.

### BRIEF DESCRIPTION OF THE DRAWINGS

Exemplary embodiments of the present invention are depicted in the figures and are explained in the description below.

FIG. 1 is a block diagram illustrating an example method according to the present invention.

FIG. 2 is a physical equivalent circuit diagram of a real internal combustion engine as used in example embodiments of the present invention.

FIG. 3 is a calculation structure used in example embodiments of the invention to model the internal combustion engine.

### DETAILED DESCRIPTION OF EXAMPLE EMBODIMENTS

The procedure will be described below using the example of the crankshaft of the internal combustion engine. The procedure is, however, applicable to any drive shaft of an internal combustion engine. This also applies in particular to the camshaft.

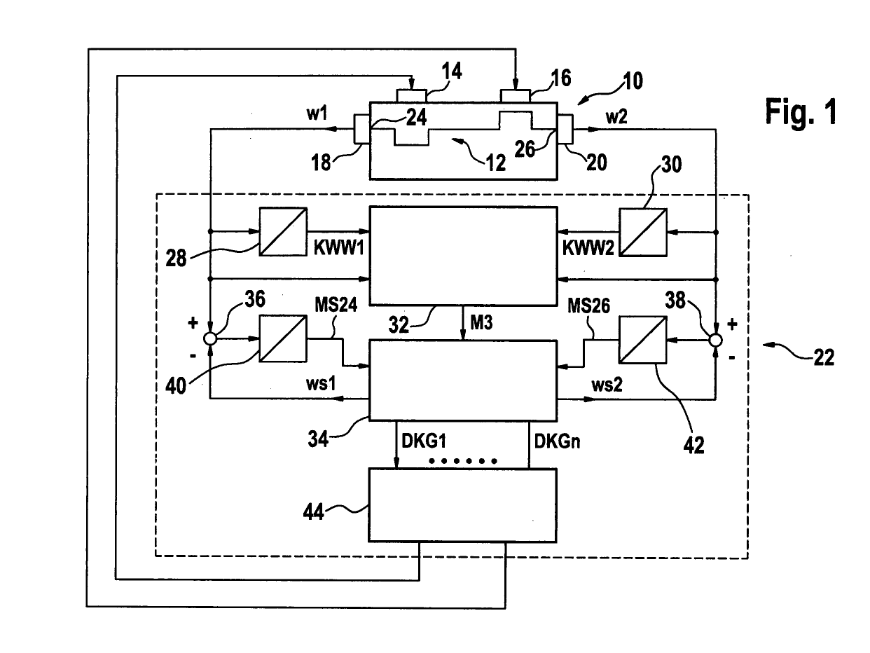

Specifically, FIG. 1 shows an internal combustion engine 10 having a crankshaft 12, individual-cylinder adjusting members 14, 16, angle sensors 18, 20, and a control unit 22. Individual-cylinder adjusting members 14, 16 are each individually associated with a cylinder or a group of cylinders of internal combustion engine 10. Examples of such adjusting members 14, 16 are fuel injection valves, positioners for an actuation of gas exchange valves that control an exchange of combustion chamber charges, throttle valves, or ignition coils; this listing is not of a conclusive nature.

A first angle sensor 18 is arranged at a first end 24 of crankshaft 12, and a second angle sensor 20 is arranged at a second end 26 of crankshaft 12. First end 24 corresponds, for example, to the end at which accessories such as generators, water pumps, steering assist pumps, and/or air conditioning compressors are driven, while second end 26 represents the actual output side at which, for example, a drive train of a motor vehicle is driven via a clutch.

Angle sensors 18, 20 sense angular velocities w1 and w2 at both ends 24, 26 of crankshaft 12 using known methods. This purpose can be served, for example, by angle sensors 18, 20 that inductively scan ferromagnetic markings on transducer wheels joined nonrotatably to ends 24, 26 of crankshaft 12. Such a scan thus corresponds to a method in which the first and the second rotation parameter are ascertained respectively as angular velocities w1, w2.

As depicted in FIG. 1, control unit 22 is subdivided into various functional blocks. A first functional block 28 and a second functional block 30 respectively represent an integrator that integrates the measured angular velocities w1, w2 to yield corresponding crankshaft angles KWW1, KWW2. A third functional block 32 represents an estimation method that, from angular velocities w1, w2 and/or from crankshaft angles KWW1, KWW2, ascertains an average engine torque M3 as a rotation parameter characteristic of the entire internal combustion engine 10.

A variety of algorithms can be used for estimation method 32. For example, average engine torque M3 can be derived from one or both measured angular velocities w1, w2. One possibility for this is offered by the aforementioned conventional method in which an effective torque proportional to average engine torque M3 is derived from the signal of a single angle sensor.

Another possibility for determining average engine torque M3 is provided by an evaluation of a static torsion of crankshaft 12. For this, the difference between crankshaft angles KWW1, KWW2 is obtained, and this difference is averaged over a suitable duration (e.g., 720° of crank angle). This average is then likewise proportional to average engine torque M3.

In the context of a further alternative, average engine torque M3 can be estimated from a dynamic torsion of crankshaft 12. For this, one or more frequency components contained in crankshaft angle values KWW1, KWW2 or in angular velocities w1, w2 are analyzed as to magnitude and phase, for example by way of a bandpass filter or with the aid of a discrete Fourier transform (DFT). The frequency of the filtered-out oscillation should be located as close as possible to one of the torsional resonant frequencies of crankshaft 12. The magnitude and/or phase of this oscillation, as well as an average angular velocity, are used as the input of a characteristics diagram whose output constitutes average engine torque M3.

A fourth functional block 34 represents an engine model that supplies the desired individual-cylinder rotation parameters DKG1, . . . , DKGn, as well as estimated values ws1, ws2 for the angular velocities of the two ends 24, 26 of crankshaft 12. Rotation parameters DKG1, . . . , DKGn are, for example, individual-cylinder torque contributions and/or angular velocities and/or individual-cylinder crankshaft angles, so that the index n in the case of the “and” conjunction runs through values from 1 to a corresponding multiple of the number of cylinders, and in the case of the “or” disjunction numbers the cylinder.

Estimated values ws1, ws2 for angular velocities w1, w2 are subtracted, by differentiating systems 36, 38, from associated measured values w1, w2 of the angular velocities, so that the resulting differences represent an indication of the deviation of estimated values ws1, ws2 (supplied by engine model 34) from the actual values w1, w2. The deviations are processed by integrators 40, 42 to yield estimated values MS24, MS26 for torques acting at ends 24, 26 of crankshaft 12, which torques serve, along with average torque M3, as input variables of engine model 34.

Differentiating systems 36, 38 therefore perform an equalization of the behavior of engine model 34 with the behavior of the real internal combustion engine 10, thus increasing the accuracy of engine model 34. Individual-cylinder rotation parameters DKG1, . . . , DKGn supplied by engine model 34 as output variables are processed by closed-loop control methods 44 to yield control variables with which the previously mentioned individual-cylinder adjusting members 14, 16 are actuated.

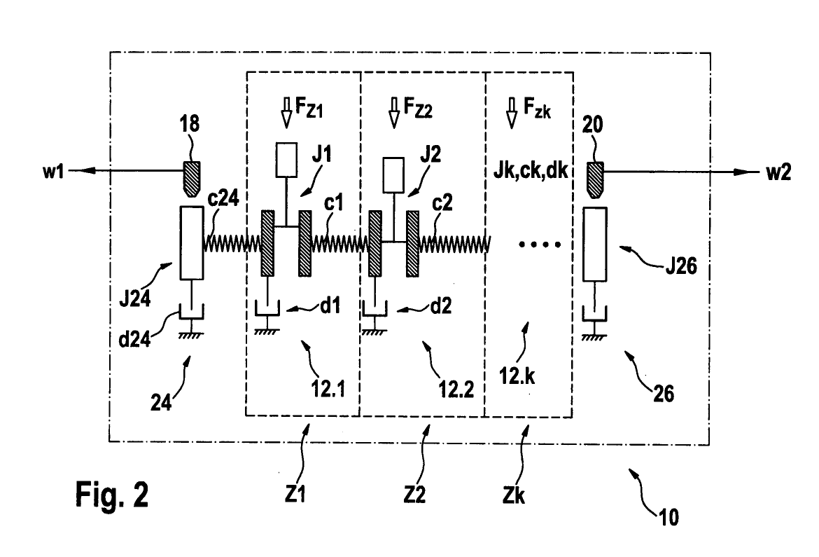

A preferred embodiment of engine model 34 is explained below. Firstly, however, a physical equivalent circuit diagram of a real internal combustion engine 10 will be described with reference to FIG. 2.

As depicted in FIG. 2, internal combustion engine 10 has a number of cylinders Z1, Z2, . . . , Zk, each having an associated crankshaft segment 12.1, 12.2, . . . , 12.k. Associated with each crankshaft segment 12.1, 12.2, . . . , 12.k is an inertial mass or inertia torque J1, J2, . . . , Jk, a damper element d1, d2, . . . , dk representing friction, and a torsional spring having a spring constant c1, c2, . . . , ck that describes a coupling to the adjacent cylinder or to the adjacent crankshaft segment. FZ1, FZ2, FZk designate the gas forces acting in cylinders Z1, Z2, . . . , ZK.

First end 24 of crankshaft 12 is made up of inertial mass J24 of a belt pulley, a damper element d24, and a torsional spring having a spring constant c24. First angle sensor 18 for sensing angular velocity w1 is mounted on the belt pulley having inertial mass J24.

Second end 26 of crankshaft 12 is made up of an inertial mass J26 on which second angle sensor 20 is mounted in order to sense second angular velocity w2.

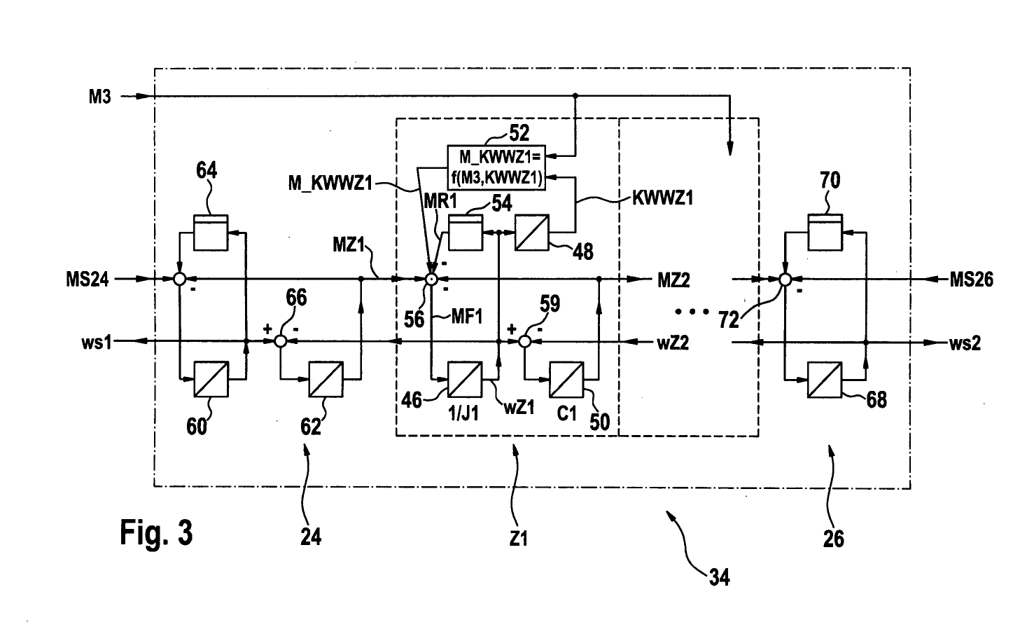

FIG. 3 describes engine model 34 in more detail. Each cylinder Z1, . . . , Zk has an equivalent circuit diagram associated with it, as explained below with reference to cylinder Z1. The equivalent circuit diagram has a first integrator 46, a second integrator 48, a third integrator 50, a block 52 that supplies an individual-cylinder torque contribution, a proportional member 54, a summing element 56, and a differentiator 59.

As will be explained below, summing element 56 supplies a free moment MF1 of cylinder Z1 to first integrator 46. First integrator 46 integrates free moment MF1, in consideration of the known inertial mass J1, to yield individual-cylinder angular velocity wZ1, thus reproducing the influence of inertial mass J1 of FIG. 2. Second integrator 48 integrates angular velocity wZ1 to yield individual-cylinder crankshaft angle KWWZ1, thus supplying an angle datum to block 52, which uses this to allocate an angle-dependent torque component M_KWWZ1 of cylinder Z1 to average torque M3 of internal combustion engine 10. Third integrator 50 integrates a difference (obtained by differentiator 59) between angular velocities wZ1, wZ2 to yield a torque MZ2 effective at the transition to the adjacent segment of the crankshaft (in this case, the transition between segments 12.1 and 12.2 of FIG. 2), spring constant C1 being taken into consideration in multiplicative fashion. Third integrator 50 thus reproduces the influence of the torsional spring having a spring constant c1.

Block 52 calculates, from average engine torque M3 supplied by estimation method 32 and from the estimated crank angle KWWZ1 of second integrator 48, the torque contribution M_KWWZ1 of cylinder Z1. This can be done, for example, by way of a characteristics diagram access, the characteristics diagram being addressed by values of average engine torque M3 and of the estimated crank angle KWWZ1. An individual-cylinder torque contribution varies over the crank angle, the individual-cylinder torque contribution supplying a contribution to the total average torque M3 of internal combustion engine 10 that is positive in the power stroke and negative at least in the intake and compression strokes. The positive contribution, in particular, is dependent on the total average torque M3 of internal combustion engine 10. Individual-cylinder torque values M_KWWZ1 whose addressing variables are located between characteristic-field points are ascertained by interpolation.

Proportional member 54 calculates the frictional torque MR1 proportional to angular velocity wZ1, and thus reproduces the influence of friction. Summing element 56 calculates—from torque contribution M_KWWZ1 of cylinder Z1, from the difference between moments MZ1 and MZ2 delivered via crankshaft 12, and from the velocity-proportional frictional torque MR1—the free moment MF1 delivered to first integrator 46, so that free moment MF1 of cylinder Z is obtained as

MF1=M_{—}KWWZ1−MR1+MZ1−MZ2.

The belt pulley at first end 24 (remote from the clutch) of crankshaft 12 is represented by two integrators 60 and 62, a proportional member 64, and a differentiator 66. These elements 60, 62, 64, 66 correspond in their significance to blocks 46, 50, 54, 59 of the cylinder model. In similar fashion, the inertial mass at the second (clutch-side) end 26 of crankshaft 12 is described by an integrator 68, a proportional member 70, and a summing element 72, by analogy with blocks 46, 54, 56 of the cylinder model.

This model 34 therefore supplies both angular velocity values and torque values, in individual-cylinder fashion in each case, as internal values of model 34 that are calculated in control unit 30, are therefore present in control unit 30, and can be taken into consideration in creating individual-cylinder control variables for adjusting members 14, 16.

1-10. (canceled)

11. A method for operating an internal combustion engine, comprising:
measuring a first rotation parameter at a first location along a shaft of the internal combustion engine;
measuring a second rotation parameter at a second location along the shaft; and
determining individual-cylinder rotation parameters using the first rotation parameter and the second rotation parameter.

12. The method as recited in claim 11, wherein the first rotation parameter and the second rotation parameter are each ascertained as an angular velocity.

13. The method as recited in claim 11, wherein in consideration of the first rotation parameter and the second rotation parameter, a third rotation parameter characteristic of the entire internal combustion engine is determined, and the individual-cylinder rotation parameters are determined from a model representing the internal combustion engine, input variables of the model being based on the first rotation parameter, the second rotation parameter, and the third rotation parameter.

14. The method as recited in claim 13, wherein the third rotation parameter is ascertained as a torque value of the entire internal combustion engine.

15. The method as recited in claim 11, wherein the individual-cylinder rotation parameters are ascertained as at least one of individual-cylinder angular velocities and individual-cylinder torque values.

16. The method as recited in claim 13, wherein for a k-cylinder internal combustion engine, the model encompasses a model of the shaft having (k+2) segments, a first segment representing a first end of the shaft, further segments each individually representing an individual-cylinder segment, and the remaining (n+2)th segment representing a second end of the shaft, each of the segments having an inertia torque and a frictional torque associated with it, the segments being respectively joined to one another by rotationally elastic couplings, each rotationally elastic coupling having a torsional torque associated with it, and each individual-cylinder segment exhibiting an individual-cylinder torque value derived from the third rotation parameter.

17. The method as recited in claim 16, wherein a torque value associated with the first segment is obtained, as a rotation parameter, from a deviation of the first rotation parameter from an estimated value of the first rotation parameter, and a torque value associated with the remaining (k+2)th segment is obtained from a deviation of the second rotation parameter from an estimated value for the second rotation parameter.

18. The method as recited in claim 11, wherein individual-cylinder control variables are obtained using the individual-cylinder rotation parameters.

19. A control unit adapted to ascertain individual-cylinder rotation parameters of a shaft of an internal combustion engine parameter sensor using a signal of the first rotation parameter sensor that senses a first rotation parameter at a first location along the shaft, and a signal of a second rotation parameter sensor that senses a second rotation parameter at a second location along the shaft.

20. The control unit as recited in claim 19, wherein the control unit is adapted to ascertain each of the first and second rotation parameters as an angular velocity.
